(19) United States
(12) Patent Application Publication
(10) Pub. No.: US 2009/0037947 A1
(43) Pub. Date: Feb. 5, 2009

(54) TEXTUAL AND VISUAL INTERACTIVE ADVERTISEMENTS IN VIDEOS

(75) Inventor: Bhushan Arun Patil, Bangalore (IN)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 11/830,157

(22) Filed: Jul. 30, 2007

(51) Int. Cl. H04N 7/10

(52) U.S. Cl. 725/32

(57) ABSTRACT

A system and method are disclosed for the insertion of interactive advertisements in videos. The interactive advertisement may be selected while the video is playing in order to display content related to the advertisement. The interactive advertisement may be text or multimedia that are embedded within the video.

### RELATED APPLICATIONS

The present application relates to applications entitled “SYSTEM FOR THE INSERTION AND CONTROL OF ADVERTISEMENTS IN VIDEO,” (Atty. Dkt. 12729/283) filed on Jul. 30, 2007, U.S. Ser. No. ______, now U.S. Pat. No. ______; and “SYSTEM FOR CONTEXTUAL MATCHING OF VIDEOS WITH ADVERTISEMENTS,” (Atty. Dkt. 12729/282) filed on Jul. 30, 2007, U.S. Ser. No. ______, now U.S. Pat. No. ______; each of which is incorporated by reference.

### BACKGROUND

Online advertising may be an important source of revenue for enterprises engaged in electronic commerce. A number of different types of web page based online advertisements (ads) are currently in use, along with various associated distribution requirements, advertising metrics, and pricing mechanisms. Processes implemented with technologies such as Hypertext Markup Language (HTML) and Hypertext Transfer Protocol (HTTP) enable a web page to be configured to contain a location for inclusion of an advertisement (ad). A page may not only be a web page, but any other electronically created page or document. An advertisement may be be selected for display within the page each time the page is requested, for example, by a browser or server application.

Traditional online advertising includes static displays of text or images on a page. However, the content available on the Internet and in web pages has become increasingly dynamic. For example, the viewing of video content online is becoming more common as consumers have access to higher bandwidth and spend more time online. Traditional online advertising has targeted users of static web pages. However, the viewing habits for online videos is different from usual text reading of web pages online. The attention of the user is focused on the screen where the video plays as compared to the viewing of scrolling text, so intermittent advertising that breaks up a video may be disruptive. Accordingly, there is a need for advertisers to provide non-intrusive advertisements to users who are viewing videos and other multimedia online.

### BRIEF DESCRIPTION OF THE DRAWINGS

The system and/or method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 is a diagram of an advertising system;

FIG. 2 is a diagram of an exemplary video distribution system;

FIG. 3 is a diagram of video editing options;

FIG. 4 is a flowchart depicting an embodiment for video editing;

FIG. 5 is an illustration of an embodiment of a video display;

FIG. 6 is a diagram of advertisement types;

FIG. 7 is an illustration of an embodiment of a video display;

FIG. 8 is a flowchart depicting an embodiment for interacting with an advertisement;

FIG. 9 is a diagram of an exemplary advertisement selection system;

FIG. 10 is a diagram of an embodiment of manual advertisement selection;

FIG. 11 is a diagram of an embodiment of automatic advertisement selection;

FIG. 12 is a flowchart depicting an embodiment for selecting advertisements;

FIG. 13 is an illustration of an interface for advertisement selection; and

FIG. 14 is an illustration of a computer system for use with the disclosed embodiments.

### DETAILED DESCRIPTION

By way of introduction, the embodiments described below include a system and method for advertising in videos. In particular, the embodiments relate to advertisements embedded or included in videos that are displayed to a viewer. The advertisements may be interactive and allow a viewer to click on the advertisement within the video. The video may be edited for the inclusion of the advertisement at the editor's discretion. In addition, the advertisement may be manually selected to optimize the editor's revenue potential. Alternatively, an advertisement to be included in a video may be automatically selected from a variety of available advertisements based on a comparison of the data related to the video with advertisement data.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

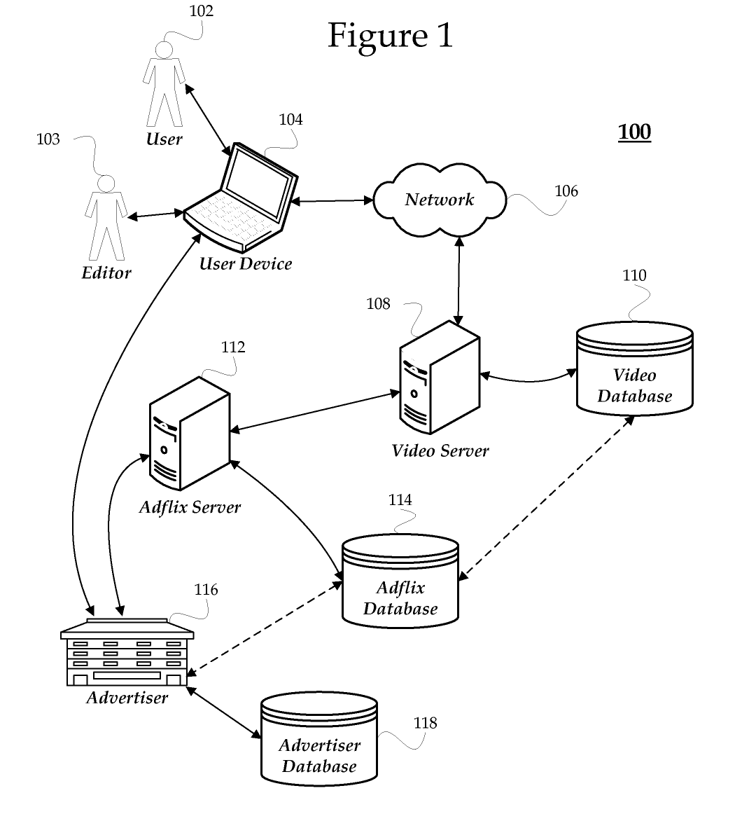

FIG. 1 illustrates a simplified advertisement network system 100 in which the present invention may be implemented. Not all of the depicted components may be required, however, and some embodiments of the invention may include additional components not shown in the figure. Variations in the arrangement and type of the components may be made without departing from the spirit or scope of the claims as set forth herein. Additional, different or fewer components may be provided.

System 100 may include a viewer 102 and/or an editor 103 who utilize a user device 104 coupled with a network 106 and configured to receive, view, and/or edit a video from a video server 108. The video server 108 may be coupled with a video database 110. An adflix server 112 coupled with an adflix database 114 may provide advertisements to the video server 108. The adflix server 112 and the adflix database 114 may be referred to as an advertising server and an advertising database, respectively. An advertiser 116 coupled with an advertiser database 118 may be coupled with the adflix server 112 for providing advertisements. Herein, the phrase “coupled with” is defined to mean directly connected to or indirectly connected through one or more intermediate components. Such intermediate components may include both hardware and software based components.

The viewer 102 and the editor 103 may include any operator of the user device 104. The viewer 102 may include a user who views a video on the user device 104. As described herein, video may include various forms of multimedia including video of any format, such as NTSC, PAL, SECAM, ATSC, DVB, ISDB, SBTVD, WMV, AVI, MPEG, MPEG2, MPEG4, or a slideshow, a series of images, or any display with or without audio. For example, the viewer 102 may be a consumer who is connected to the Internet through the user device 104 and views a video on a web page shown on the user device 104. The editor 103 may include a user who edits a video on the user device 104. In addition, the editor 103 may also create videos that may be provided or uploaded to the video server, which may then be edited or viewed by others. In one example, the editor 103 may access videos from the video server 108 and edit them to include advertisements. In one embodiment, the advertiser 116 may be an editor who edits videos to include advertisements. In one embodiment, the editor 103 may also be a viewer 102 because in order to edit the video it may be viewed. As described herein, the viewer 102 and the editor 103 may be described as a user.

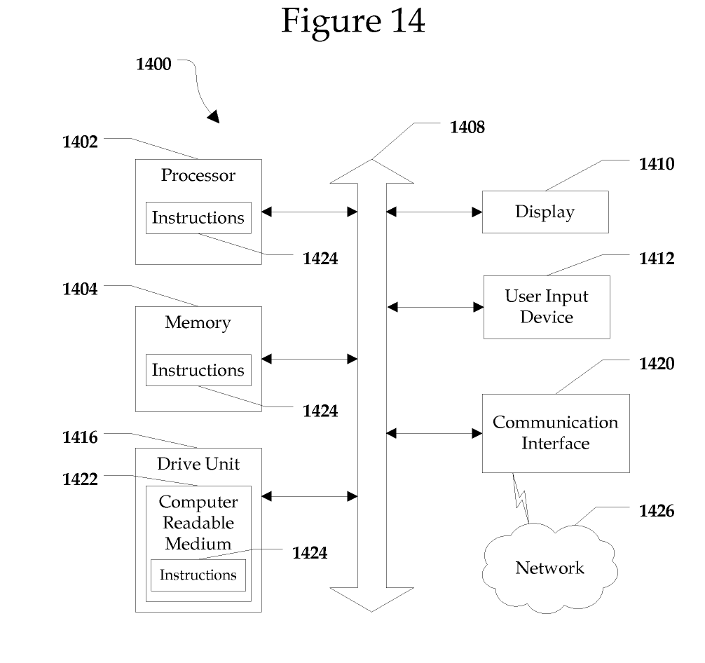

The user device 104 may be a computing device connected to the network 106, such as the Internet. Examples of the user device 104 include but are not limited to a personal computer, personal digital assistant (“PDA”), cellular phone, smart phone, Blackberry®, digital video recorder (“DVR”), personal video recorder (“PVR”), network-enabled television, automobile, navigation system, or other electronic device configured to display a video. The user device 104 may enable the viewer 102 to view pages over the network 106, or may provide the editor 103 with an interface for accessing videos to edit. The user device 104 may be configured to access data/information over the network 106 with a web browser, such as INTERNET EXPLORER® (sold by Microsoft Corp., Redmond, Wash.). The data displayed by the browser may include video and/or advertisements. In an alternative embodiment, other software programs may also display video and/or advertisements received over a network or from a different source. The user device 104 may comprise the user device described below with respect to FIG. 14.

The user device 104 may be configured to allow the viewer 102 or editor 103 to interact with the video server 108 or other components of the system 100. In one embodiment, the user device 104 may receive and display a site or page provided by the video server 108 that includes a video. The user device 104 may include a keyboard, keypad or a cursor control device, such as a mouse, joystick, touch screen display, remote control or any other device configured to allow interaction with the page(s) or video(s) provided by the video server 108. The video server 108 may comprise the computing device described below with respect to FIG. 14.

The video server 108 provides a site or a page over the network 106, such as the Internet. The site or page may refer to a web page or a series of related web pages which may be received or viewed over a network and includes or provides an embedded video or a link to a video, which may be viewed or edited on the user device 104. The site or page is not limited to a web page, and may include a video or any other information accessible over a network that may be displayed at the user device 104. As described below, the page may include a video, along with video editing capabilities, such as the ability to add advertisements to videos.

The video database 110 may store any number of videos or other multimedia files which may be provided by the video server 108 over the network 106. As described below, the files that are stored and transferred by the video server 108 to/from the video database 110 will be described as videos, although other files, including other multimedia may also be transferred and stored. The video database 110 may store multiple versions of videos, including an original video and edited videos, which may include advertisements. The video server 108 may provide the user device 104 with videos for viewing by the viewer 102 or for editing by the editor 103, which were stored in the video database 110. In addition, newly created or edited videos from the user device 104 may be uploaded or transferred over the network 106 by the video server 108 to the video database 110 for storage.

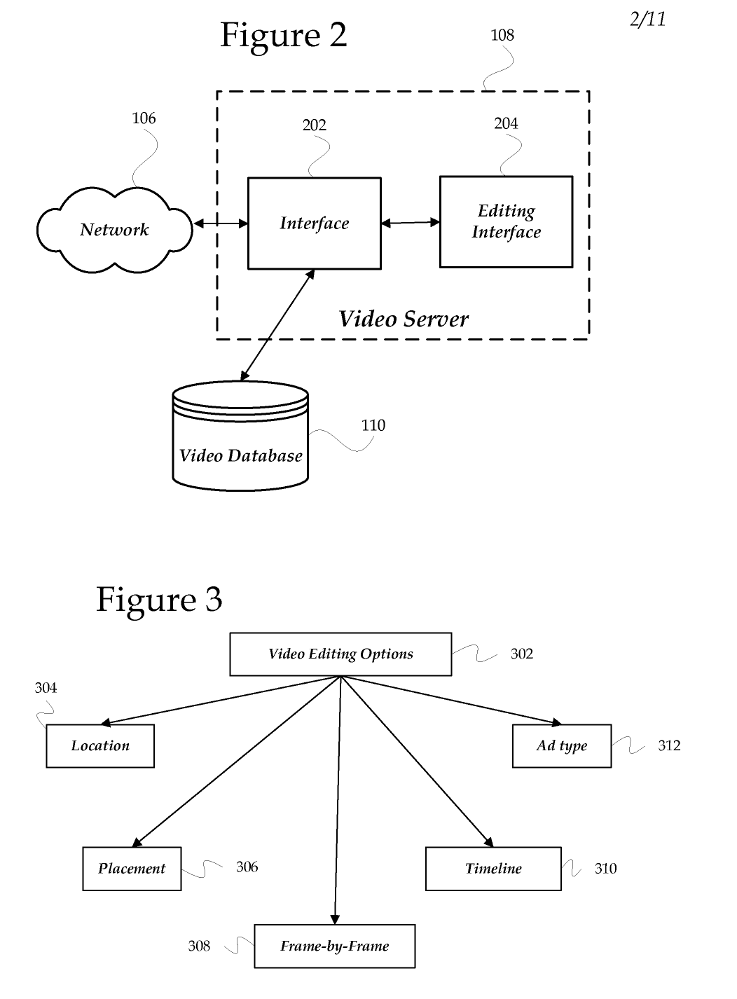

FIG. 2 illustrates one embodiment of the video server 108. The video server 108 may comprise an interface 202 coupled with an editing interface 204. The interface 202 may include at least one communication port configured to communicate over the network 106, such as with the user device 104, or to communicate with the video database 110. Additionally, the interface 202 may be coupled with other components in system 100, such as the adflix server 112, the adflix database 114, and/or the advertiser 116. In one embodiment, the interface 202 receives and transmits videos to and from the video database 110 and to/from the network 106. The interface 202 may be created in software or may be a physical connection in hardware. The connection with the network 106 or the other components may be a physical connection, such as a wired Ethernet connection or may be established wirelessly as discussed below with respect to the network 106.

Any of the components in system 100 may be coupled with one another through a network, or networks, such as the network 106. For example, the video server 108 may be coupled with the adflix server 112, the video database 110, and/or the adflix database 114 over a network. Likewise, the advertiser 116 may be coupled with the adflix server 112, the adflix database 114, and/or the advertiser database 118 over a network. The network or networks, such as the network 106 that may connect any of the components in the system 100 may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or a WiMax network. Further, the network(s) may be a public network, such as the Internet, a private network, such as an intranet, or combinations thereof, and may utilize a variety of networking protocols now available or later developed including, but not limited to TCP/IP based networking protocols.

The network(s), including the network 106, may include one or more of a local area network (LAN), a wide area network (WAN), a direct connection such as through a Universal Serial Bus (USB) port, and the like, and may include the set of interconnected networks that make up the Internet. The present disclosure contemplates a computer-readable medium that includes instructions or receives and executes instructions responsive to a propagated signal, so that any device connected to a network can communicate voice, video, audio, images or any other data over a network. For example, the video server 108 may provide pages with videos to the user device 104 over a network, such as the network 106. The network or networks described above, including the network 106, may be the network discussed below with respect to FIG. 14.

The editing interface 204 of the video server 108 is coupled with the interface 202 and configured to provide the editor 103 with the ability to edit videos. In one embodiment, the interface 202 provides a page with editing options for modifying a video, such as embedding an advertisement within a video. The editor 103 may have access on the user device 104 to a video from the video server 108. The video server 108 may provide tools for editing the video to include an advertisement, which may be from the adflix server 112 as discussed below.

FIG. 3 illustrates examples of editing options 302. In particular, the editing options 302 include various alternatives for including an advertisement in a video. The location 304 of an advertisement may be varied. The location 304 may refer to the spot within the video display screen where the advertisement appears. For example, the advertisement may be included at a particular location within the video, such as along the bottom of the video. The placement 306 may refer to the time period within the video that the advertisement is shown. In particular, the placement 306 may include additional options of frame-by-frame 308 or timeline 310 editing of the video.

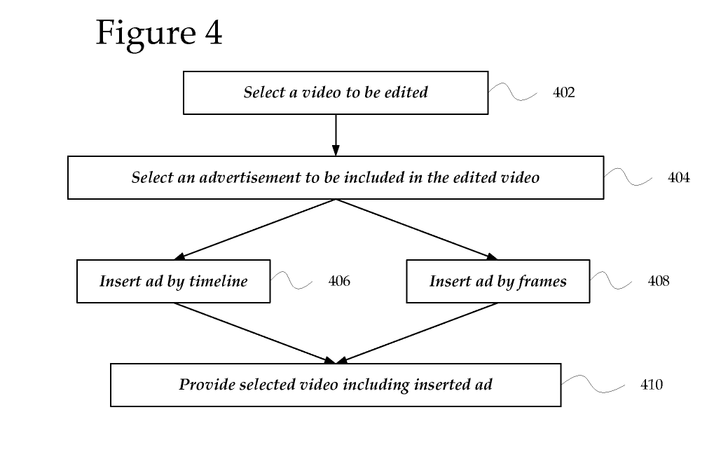

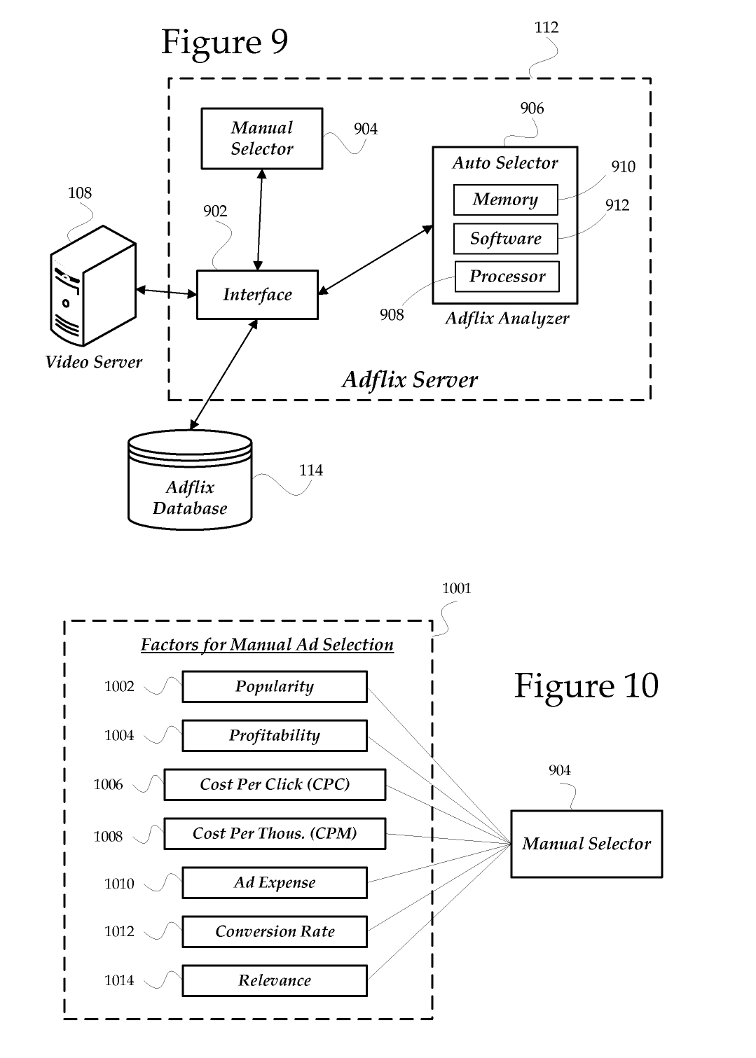

FIG. 4 is a flow diagram illustrating the editing of a video by either the timeline 310 or frame-by-frame 308 editing options. In block 402, a video is selected for editing. The video may be selected from the video database 110 and transferred by the video server 108 to the user device 104. In block 404, an advertisement is selected for inclusion in the edited video. The selection of an advertisement may be accomplished by the adflix server 112 as described below with respect to FIGS. 9-12. The selected advertisement may be inserted into the video with an advertisement timeline as indicated in block 406. In particular, the timeline 310 may provide a mechanism for inserting an advertisement in a video for a set period of time. For example, the editor 103 editing the video may insert an advertisement that appears one minute into the video and is displayed for one minute before being removed at the two minute mark. Accordingly, the placement 306 may include an option for the duration of the display of the advertisement.

Alternatively, the advertisement may be inserted into the video by selecting certain frames from the video in which the advertisement may appear, as indicated in block 408. In particular, the frame-by-frame editing option 308 allows an advertisement to be displayed in certain frames within the video. In one embodiment, the editor 103 editing the video may select an initial or start frame in which the advertisement will appear and select a final or last frame in which the advertisement appears. In other words, all frames of the video before the start frame and all frames after the stop frame do not include the advertisement. After the advertisement is inserted in the video, the edited video may then be provided for viewing, as indicated in block 410.

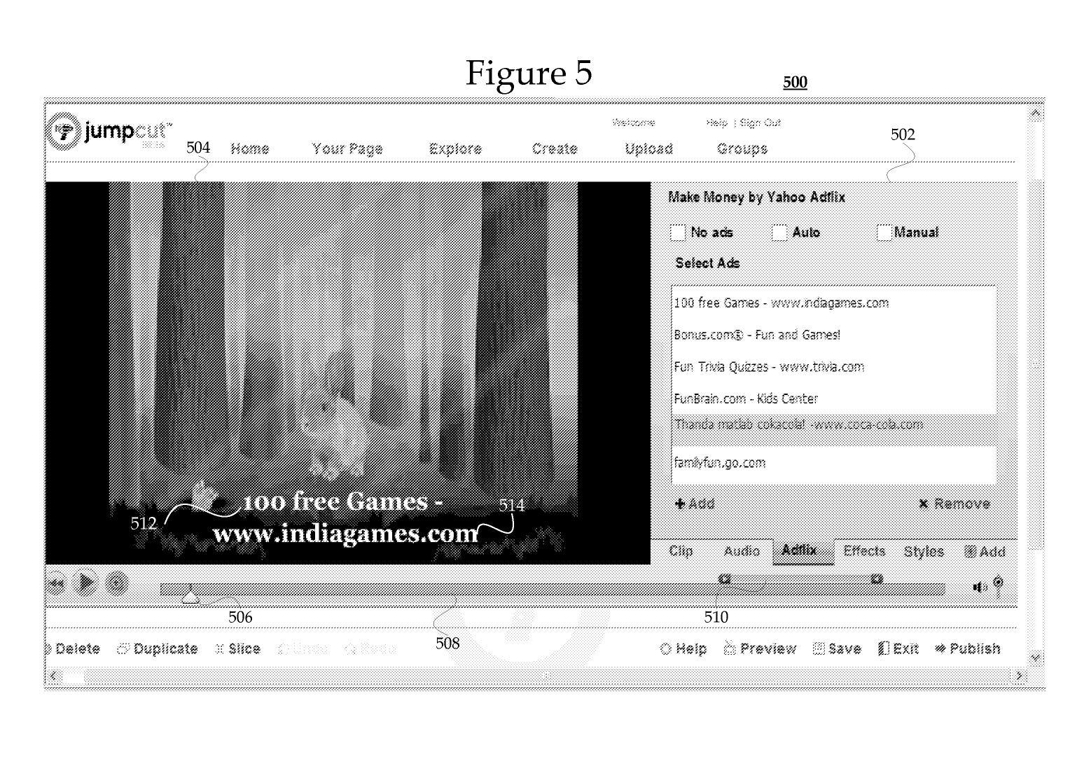

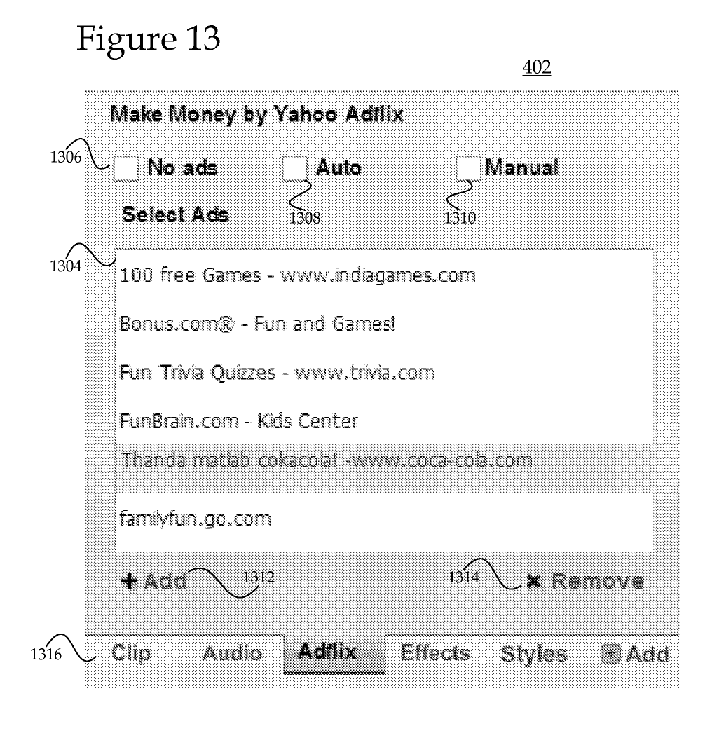

FIG. 5 illustrates one example of an advertisement in a video 504. A page 500 may be a web page or other page which may display the video 504. The video 504 is shown on a portion of the page 500. The page 500 may include controls for the video, such as play, stop, pause, rewind, fast forward, skip and edit buttons. The video 504 may be edited and/or selected by an adflix editor 502 as will be described below with respect to FIG. 13. An advertisement 512 may be displayed within the video, as well as a hyperlink 514. As shown, the advertisement 512 and hyperlink 514 are both portions of the same advertisement.

The frame-by-frame 308 or timeline 310 editing options are illustrated by FIG. 5. In particular, a timeline 508 for the video 504 is shown, along with a cursor 506 that illustrates the current frame or timeline position of the video. The cursor 506 may be adjusted along the timeline 508 to view any section of the video, as well as to identify individual frames of the video. Accordingly, the cursor 506 may be used to select frames which are edited frame-by-frame 308, such as to include an advertisement.

In one embodiment, the timeline may include an edited timeline 510 which identifies a section of the video, such as a portion of the timeline 508 or a plurality of frames. The edited timeline 510 may identify the edited portion of the video 504, such as the portion of the video 504 that includes an advertisement. The length of the edited timeline 510 may be adjusted to either increase or decrease the amount of time the advertisement is displayed. The longer the edited timeline 510, then the longer the advertisement is shown. The edited timeline 510 may be moved to appear at any portion of the timeline 508, such as the beginning, middle, or end of the timeline 508. There may be multiple edited timelines 510, each of which corresponds to a different advertisement being displayed.

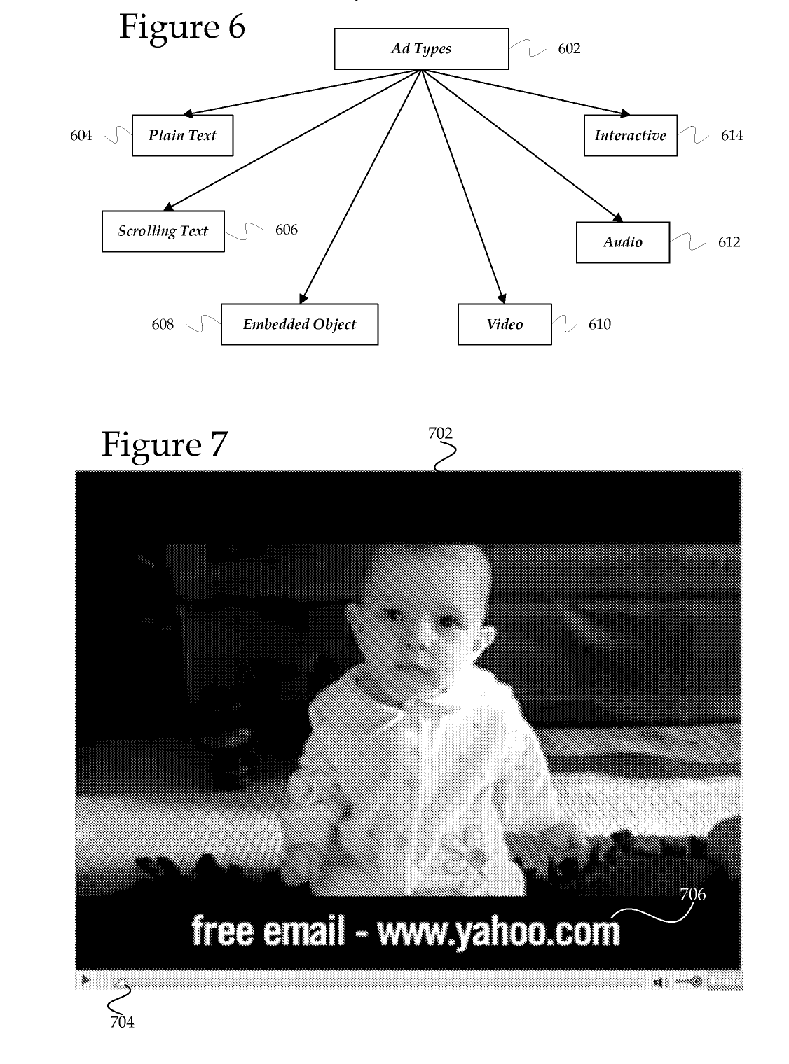

Referring back to FIG. 3, an additional editing option includes the advertisement (ad) type 312. The advertisement may be displayed in a variety of forms as illustrated in FIG. 6. In particular, FIG. 6 illustrates examples of possible ad types 602 for advertisements included in videos, such as plain text 604, scrolling text 606, an embedded object 608, a video 610, audio 612, and an interactive 614 advertisement. The plain text 604 may include a description that identifies a product or service. For example, the plain text 604 may include the name or web address of a web site that is advertising a product.

FIG. 7 is an illustration of an advertisement in a video. In particular, FIG. 7 illustrates the display of a plain text 604 advertisement in a video 702. The video 702 is displayed and plays for the length of the timeline 704. For at least a portion of the timeline 704, an advertisement 706 is embedded in the video 702. In this embodiment, the advertisement 706 is text that is shown as part of the video 702. As shown, the advertisement 706 may be the plain text 604 at type.

Alternatively, the text of an advertisement may be scrolling text 606. For example, the advertisement 706 may not be stationary within the video 702, but may scroll from one side of the screen to the other. The scrolling text 606 may include additional words or a description of the product and/or service being advertised. Plain text 604 may be limited to a few words to fit within the frame of the video 702, but because scrolling text 606 moves into and out of the screen, an additional description may be included with more words to describe the product.

An embedded object 608 may include product placement within a video. A soft drink advertiser may include a soft drink container on a table within the video. For example, during a video of a birthday party, a two-liter bottle of the soft drink may be embedded into the video to be displayed on a table next to the birthday cake. The embedded object 608 may be designed to fit into the video, so a viewer may not realize that the advertisement was embedded in the video. Conversely, the plain text 604 and the scrolling text 606 ad types may be recognized by a viewer 102 as being added to the video. An embedded object 608 may be seamlessly included in the video. Additional examples include posters added to walls, billboards added to streets, or advertisements added to clothes. The embedded object 608 may appear to be a seamless part of the video, such that the viewer may not realize the advertisement is present in the video.

A video 610 advertisement may be included in a video. In one embodiment, video 610 may be a form of an embedded object. For example, if a television appears in a video, then a video 610 advertisement, such as a commercial, may be embedded in the television within the video. A viewer of the video who sees the television displaying the commercial may not realize the commercial is embedded in the video.

An audio 612 advertisement may include a verbal description of a product/service which may be included in a video. The audio 612 advertisement may be included during a portion of the video without other sound. Alternatively, the audio 612 advertisement may be an embedded object in the video, such that the embedded audio 612 is seamlessly incorporated into the video. In one example, a newly released song may be included within a video by replacing a portion of the original soundtrack or audio as a way of advertising the song. If a video shows a radio or music player, the audio from that music player in the video may be replaced with the audio 612 advertisement.

Any of the ad types 602 may also be an interactive 614 ad type. An interactive 614 advertisement responds to an action by the viewer 102 of the video. For example, in FIG. 7, the advertisement 706 of “free email—www.yahoo.com” may be interactive. In particular, the text of the advertisement 706 may be clickable or selectable, such as a hyperlink, allowing a viewer to click or select the advertisement 706, which links to another page related to that advertisement.

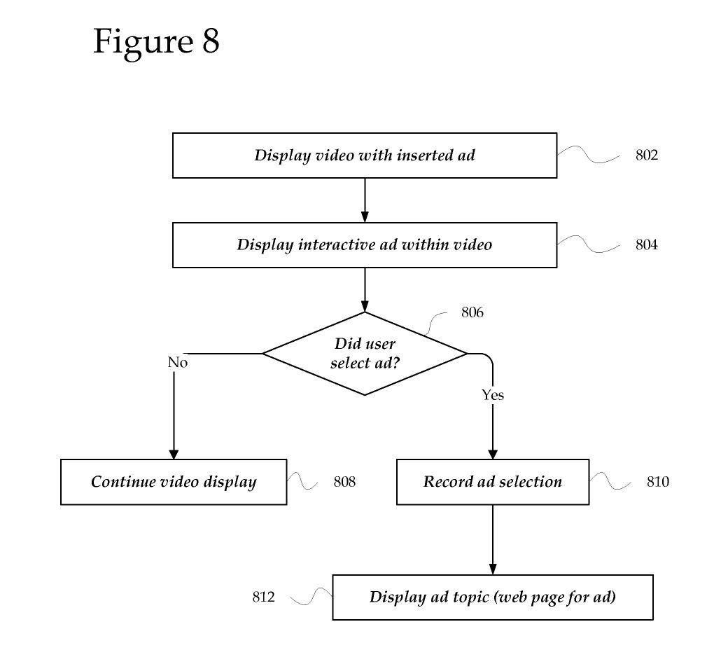

FIG. 8 is a flow diagram illustrating one example for interacting with an advertisement. A video with an inserted interactive 614 advertisement is displayed in block 802 and the viewer 102 views the video on the user device 104. The video may be stored in the video database 110 and transmitted to the user device 104 by the video server 108. When the video is displayed on the user device 104, the interactive advertisement is displayed within the video as in block 804.

In block 806, a determination is made as to whether the viewer 102 has selected or interacted with the interactive advertisement 614 in the video. The type of interaction of an interactive advertisement 614 varies depending on the medium on which the video is viewed. For a video displayed on a web site or downloaded and displayed on another viewing software program (such as Windows Media Player®, Real Player®, or iTunes®), the interaction may include moving a cursor over the advertisement and clicking, such as with a mouse or a keyboard. Alternatively, the video may be directly viewed on a television, such as with a digital video recorder (DVR) or other set top box (STB) configured to provide videos. A remote control of the television, DVR, or STB may be used to move a cursor and/or select the advertisement shown in the video. For example, the viewer 102 may click on or select a Pepsi® can displayed in a video, which may result in further information on Pepsi®, such as the display of the Pepsi® website.

The interaction with the interactive advertisement 614 may not be limited to a selection of the advertisement. A mouse click anywhere on the video while an interactive 614 advertisement is shown may result in additional information regarding the advertisement. Alternatively, there may be a button or additional selectable tool, which may be selected when the advertisement is displayed. For example, a button near the video controls (play, pause, stop, fast forward, rewind, skip) may be labeled “More Info,” “Ad info,” or include different identification. Interaction with or clicking of the button may result in more information being displayed regarding the current advertisement that is being displayed.

At any frame or timeline within a video, there may be multiple advertisements. For example, an object may be embedded within the video as well as a plain or scrolling text display within the video. The interaction for multiple advertisements that are shown simultaneously may distinguish between which advertisement the viewer 102 would like to interact with. The individual advertisements may each be clickable. An interaction with a neutral area in the video (not in the vicinity of an advertisement) may produce a menu or options by which the viewer 102 may select a particular advertisement display.

When there is no interaction with the interactive advertisement 614, the video continues as indicated in block 808. When the system detects an interaction with the interactive advertisement 614, the selection is recorded as indicated in block 810. In particular, the type of interaction may determine the response to the interaction. The interaction with an advertisement may result in a variety of responses. In one embodiment, an additional page, such as web page, may be displayed including the advertised product/service. For example, clicking on the advertisement 706 in FIG. 7 may result in a web page displaying the site www.yahoo.com that is advertised in the video 702. In block 812, an advertisement topic is displayed, such as a web page of the advertisement, based on the selection or interaction with the advertisement.

The result of the interaction of an interactive advertisement 614 may vary based on the medium on which the video is viewed. If the video is viewed on a web page, or over the Internet, then the interaction may result in an additional web page being displayed as discussed above. For a video displayed on a web page, the interaction may provide an output within the page displaying the video. For example, when the video does not cover all areas of the web page, an interaction with an advertisement within the web page may result in a further display of the advertisement outside of the video, but on the same page as the video. The additional display of the advertisement may include additional advertisements related to the product/service advertised by the original advertisement in the video. For example, an interaction with an advertisement in a video may result in the banner ad on a web page being changed to advertise the product/service from the advertisement.

Alternatively, the video may be a standalone video viewed on a television or monitor. Viewer interaction with the advertisement may result in additional information being displayed. For example, if a viewer clicks on a plain text 604 ad displayed in a video, then additional information may be displayed, such as scrolling text 606 providing further details about the advertised product/service. The information may be displayed within the video, adjacent the video, or on a separate page.

Referring back to FIG. 1, the system 100 includes the adflix server 112, which may be coupled with the video server 108 and configured to provide advertisements for videos transferred by the video server 108. In particular, the adflix server 112 may provide a platform for selection, optimization, and/or distribution of advertisements for inclusion in video displayed on a page, such as a web page. In an alternative embodiment, the adflix server 112 and the video server 108 may be combined. The adflix server 112 may comprise the computing device described below with respect to FIG. 14.

The adflix server 112 may provide advertisements to be included in a video from the video database 110, which may be transmitted over the network 106. The adflix server 112 may be coupled with the user device 104 over the network 106 to allow the editor 103 to select, create, or edit advertisements to be included in videos provided by the video server 108. In one embodiment, the editing options 302 and ad types 602 may be made available to editors and established by the adflix server 112.

FIG. 9 illustrates one embodiment of the adflix server 112. The adflix server 112 may comprise an interface 902 coupled with a manual selector 904 and an auto selector 906. The interface 902 may be similar to the interface 202 in the video server 108. The interface 902 may include at least one communication port configured to communicate over the network 106, such as with the user device 104, or the video server 108, and/or the adflix database 114. Additionally, the interface 902 may be coupled with other components in system 100, such as the video database 110, the advertiser 116, and/or the advertiser database 118. In one embodiment, the interface 902 receives and transmits advertisements to and from the video server 108, the adflix database 114, or the user device 104 over the network 106. The interface 902 may be created in software or may be a physical connection in hardware. One embodiment of interface 902 is shown and described with respect to FIG. 13.

The interface 902 may be coupled with the adflix database 114 and configured to transmit advertisements to and from the adflix database 114. The adflix database 114 may store advertisements which may be selected for inclusion in videos transmitted by the video server 108. In one embodiment, the editor 103 may edit a video on the user device 104 and may select advertisements from the adflix database 114 to be included in the video, which may bring in potential revenue for the editor 103 as discussed below. In addition, advertisements may be generated which may be stored in the adflix database 114 for others to access. For example, the editor 103 may create or modify advertisements which are stored in the adflix database 114. As discussed below, the advertisements in the adflix database 114 may also be provided by advertisers, such as advertiser 116.

The selection of advertisements may be conducted from the manual selector 904, or the auto selector 906, both of which may be coupled with the interface 902. The manual selector 904 may be configured to allow a video editor to select an advertisement to be included in a video. In one example, the manual selector 904 may be implemented in software. The manual selector 904 may be coupled with the video server 108 and accessible by the editor 103. Additionally, the manual selector 904 may be coupled with the adflix database 114, the advertiser 116, and/or the advertiser database 118 for receiving information related to the advertisement. The information related to the advertisement may be relevant for the selection of an advertisement.

FIG. 10 is an illustration of an embodiment for the manual selection of an advertisement. In particular, FIG. 10 illustrates the manual selector 904 and examples of possible factors 1001 for manual advertisement selection. The manual ad selection factors 1001 are merely exemplary of considerations for the editor 103 upon selecting an advertisement for display in a video. In one embodiment, the manual ad selection factors 1001 may be provided to the editor 103, who may view the factors 1001 for all available advertisements when selecting an advertisement to be included in the video.

The popularity 1002 of an advertisement or advertised product/service may be a factor 1001 for manual advertisement selection. The popularity 1002 may be reflected by the number of hits (clicks or interactions) an advertisement has had within other videos, or on other mediums, such as on a web page. Alternatively, the popularity 1002 may be determined by the number of searches on a search engine. The more popular products/services (advertisements) may be searched for more frequently. Search results may also reflect trends in popularity to identify items that may be increasing in popularity. Popularity of a product/service being advertised may also be reflected in the sales of the product/service. The editor 103 selecting advertisements may want the more popular advertisements of the more popular products/services because they may be more likely to be interacted with by viewers of the video, which may result in payments for the advertisement.

The profitability 1004 of an advertisement or advertised product/service may be a factor 1001 for manual advertisement selection. The payment from an advertiser, such as the advertiser 116, to the editor 103 for using the advertiser's advertisement may result in a payment depending on how the advertisement is incorporated in the video. In one embodiment, the advertisement payment may be based on the editing options 302, such as the location or placement of the advertisement. The longer the advertisement is displayed the higher the value may be for the advertiser. The context of the advertisement may also result in additional value for the advertisement. For example, product placement with a villain in a video may be detrimental for the product, but product placement with a hero in a video may be worth more for the advertiser. Accordingly, the profitability 1004 or the reward for the editor 103 for using a particular advertisement in a video may be a factor in selecting that advertisement.

The cost per click (CPC) 1006 and cost per thousand (CPM) 1008 of an advertisement or advertised product/service may be factors 1001 for manual advertisement selection. In particular, CPC 1006 and CPM 1008 are advertising payment methods by which the provider of the advertisement (video editor) may be paid by the advertising entity, such as the advertiser 116. CPC 1006 refers to a price that is paid each time an advertisement viewer interacts with an advertisement, such as by clicking on the advertisement to view a web site associated with the advertisement. A price is paid each time a viewer clicks on (interacts with) an advertisement within a video. In one embodiment, the price may be in a range of $0.01 to $0.50. CPC 1006 may also be referred to as pay per click (PPC) advertising.

CPM 1008 may be referred to as cost per mille, cost per thousand, or cost per impression. CPM 1008 may result in a payment based on the number of times that an advertisement is viewed, rather than based on the number of interactions. The number of viewings of the advertisement may be referred to as impressions. The CPM 1008 may establish a price that is paid for every one thousand impressions. For example, an advertiser may pay $20 CPM, which is $20 for every one thousand views (impressions) of the advertisement in a video. Alternatively, a price may be established for a different number of impressions, such as every 100, 500, or 10,000 impressions. The CPM 1008 payment method may be more effective for a popular video in which the viewers do not click on the advertisements. When the viewers are more likely to click on the advertisements, then the CPC 1006 payment method may be more profitable.

The advertisement expense 1010 of an advertisement or advertised product/service may be a factor 1001 for manual advertisement selection. The advertisement expense 1010 may refer to an advertisement in which the video editor may pay a fee for an initial use of an advertisement. Alternatively, the advertisement expense 1010 may refer to any costs associated with including the advertisement in the video. There may be no advertisement expenses associated with certain advertisements.

The conversion rate 1012 of an advertisement or advertised product/service may be a factor 1001 for manual advertisement selection. The conversion rate 1012 may reflect the rate at which viewers of an advertisement interact with that advertisement. The interactions may be referred to as conversions. Certain advertisements in videos may result in higher conversion rate than others and in a CPC 1006 payment setup, more conversions results in a greater payment. Accordingly, the editor 103 may select advertisements with a higher conversion rate 1012.

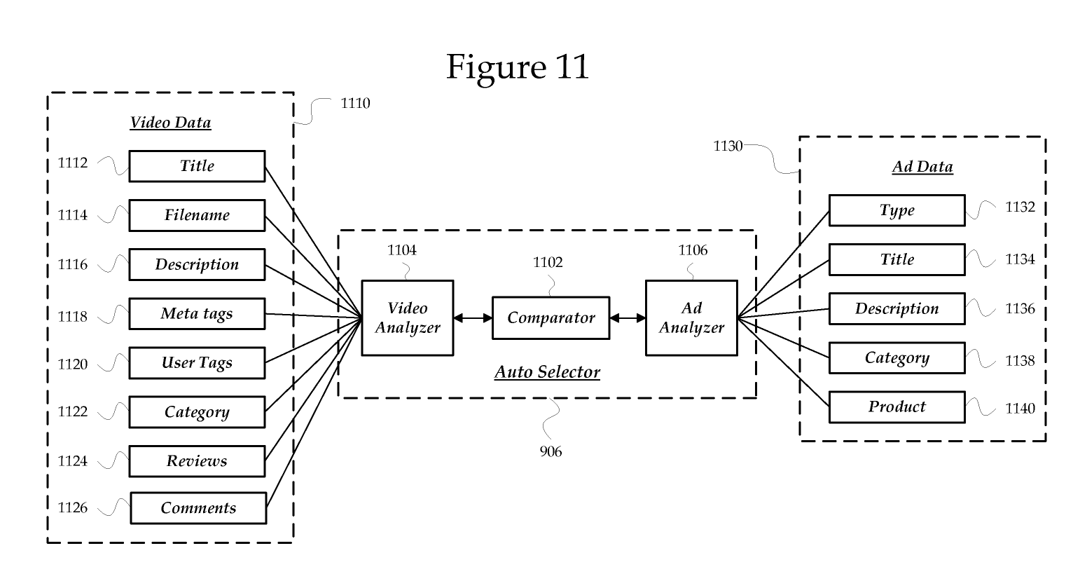

The relevance 1014 of an advertisement or advertised product/service may be a factor 1001 for manual advertisement selection. Relevance 1014 may reflect the relationship of an advertisement with the video. For example, a video related to baseball may have sports or baseball related advertisements selected for inclusion in the video. Viewers of a baseball video may be more likely to view and/or interact with advertisements related to sports. Accordingly, the editor 103 may consider the relevance 1014 of each advertisement to the video being edited. The relevance 1014 may be reflected in a comparison of ad data 1130 and video data 1110 as discussed below in FIG. 11. In particular, the ad data 1130 for available advertisements and the video data 1110 may be provided to and considered by the editor 103 when selecting an advertisement for inclusion in a video.

Referring back to FIG. 9, the adflix server 112 includes an auto selector 906 coupled with the interface 904. The auto selector 906 may also be referred to as an adflix analyzer and configured to analyze and compare available advertisements with a video for selecting advertisements to be displayed in that video. The auto selector 906 may be a computing device as described with respect to FIG. 14 and may include a processor 908, a memory 910 and software 912.

The processor 908 is configured analyze and compare data for selecting advertisements. The processor 908 may be a central processing unit (CPU), a graphics processing unit (GPU), digital signal processor (DSP) or other type of processing device. The processor 908 may be a component in a variety of systems. For example, the processor 908 may be part of a standard personal computer or a workstation. The processor 908 may be one or more general processors, digital signal processors, application specific integrated circuits, field programmable gate arrays, servers, networks, digital circuits, analog circuits, combinations thereof, or other now known or later developed devices for analyzing and processing data. The processor 908 may operate in conjunction with a software program, such as code generated manually (i.e., programmed).

The processor 908 may include a memory 910, or the memory 910 may be a separate component. The memory 910 may comprise the adflix database 114 for storing available advertisements. The memory 910 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 910 includes a random access memory for the processor 908. In alternative embodiments, the memory 910 is separate from the processor 908, such as a cache memory of a processor, the system memory, or other memory. The memory 910 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data. The memory 910 is operable to store instructions executable by the processor 908. The functions, acts or tasks illustrated in the figures or described herein may be performed by the programmed processor 908 executing the instructions stored in the memory 910. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

In one embodiment, the software 912 may be stored in memory 910. The processor 908 is configured to execute the software 912. The software 912 may include a browser or other video editor program. The browser may be a web browser configured to display information and data retrieved from the Internet or other network. For example, the browser may be INTERNET EXPLORER®, or some other web browser. The browser may be configured to receive, display, and edit videos.

One embodiment of the auto selector 906 is shown in FIG. 11. In particular, FIG. 11 illustrates the video data 1110 and the ad data 1130 that may be analyzed and compared when selecting an advertisement. The auto selector 906 may include a video analyzer 1104 coupled with a comparator 1102, which is also coupled with an ad analyzer 1106. The video analyzer 1104 may compile and analyze the video data 1110 from a video in which an advertisement will be included. The ad analyzer 1106 may compile and analyze the ad data 1130 from available advertisements which may be included in the video. The comparator 1102 receives the analysis from both the video analyzer 1104 and the ad analyzer 1106 to determine the similarities between particular advertisements and the video. The comparator 1102 may determine the relevance 1014 of an advertisement to a particular video.

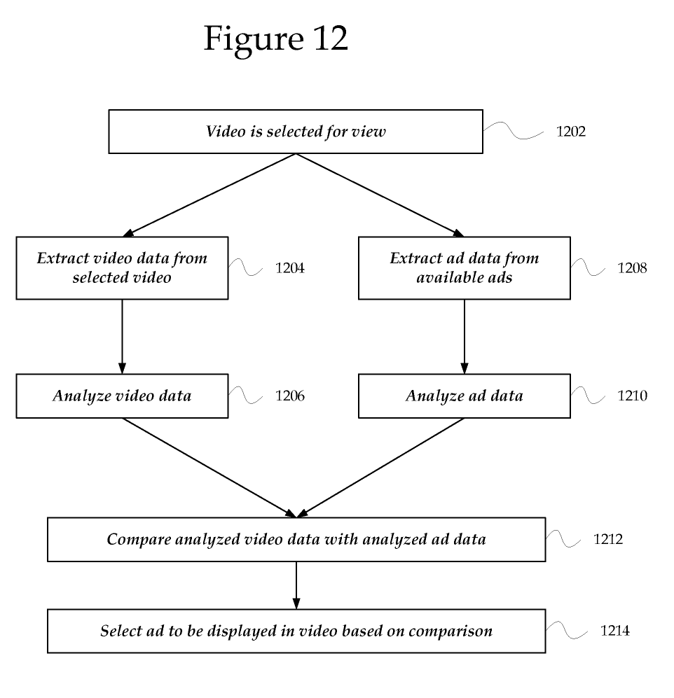

FIG. 12 is a flow diagram of one embodiment of advertisement selection. In particular, FIG. 12 illustrates an example of selection of an advertisement by the auto selector 906. A video that may be edited to include an advertisement is chosen in block 1202. In block 1204, the video data 1110 is extracted from the video.

The video data 1110 may include any relevant information related to a video in which an advertisement may be included. The title 1112 and/or the filename 1114 of the video may be relevant to the content of the video. The title 1112 and/or the filename 1114 may be named based on the content of the video. Likewise, the description 1116 of a video may be generated to describe a particular video.

A video may be tagged with information that relates to the topic of a video. For example, meta tags 1118 and user tags 1120 may be associated with the video. A tag may describe a video as “baseball” or “sports” and that tag may be used to select an advertisement that is related to either baseball or sports. The meta tags 1118 may include any information related to user targeting from the video service provider related to that video. The user tags 1120 may be created by the viewer 102 of the video, who creates a user tag 1120 as a form of categorizing the video. In one embodiment, the title 1112, filename 1114, and/or description 1116 may be analyzed to look for keywords or terms, such as the tags 1118, 1120, which may be compared with the ad data 1130.

The category 1122 of a video may also be relevant video data 1110. In some video sharing websites, such as YouTube® or Yahoo! Videos®, the videos that are available on the site may all be categorized. The category of a video may provide relevant information on the video. Similar, to the other video data 1110, a video may be categorized under a Sports category or a Baseball category and the comparator 1102 may then select advertisements related to those categories. Likewise, reviews 1124 of a video and/or comments 1126 from a video may also be used to determine the subject matter of a video. A video site may allow viewers to post reviews of the video, or post comments regarding the video. The reviews 1124 and the comments 1126 may be analyzed by the video analyzer 1104 to identify keywords that may be used by the comparator 1102. In one embodiment, the category 1122 or a sub-category may be the keyword for the video.

After the video data is determined in block 1204, the video data may be analyzed by the video analyzer 1104 as in block 1206. The video analyzer 1104 may analyze the video data 1110 to find keywords which reflect the content of the video. The keywords may be an individual word describing the video, such as “baseball,” or may be a phrase, such as “top baseball plays.” The identified keywords may be compared with keywords related to the available advertisements.

In block 1208, the ad data 1130 is extracted from the available advertisements. The ad data 1130 may include a type 1132 of advertisement. The type 1132 may refer to the ad types 602 illustrated in FIG. 6. In particular, the type 1132 may include plain text, scrolling text, embedded objects, video, audio, images, or an interactive advertisement. The type 1132 of advertisement may determine whether it would fit with a particular video. For example, a music video may not want to include an audio advertisement because that may be disruptive to the viewer.

Available advertisements may have a title 1134. The title 1134 of an advertisement may be similar to the title 1112 of a video. The title may be a simple description of the advertisement. Likewise, each advertisement may include a description 1136. The advertisements may be organized into categories 1138. The categories 1138 may reflect the topic of the advertisement, or be organized based on the ad type. For example, audio advertisements may be in one category, with sub-categories that reflect the type of audio in the advertisement. The product 1140 is the subject of an advertisement and may also include a service. The product 1140 represents the item that is being advertised. Any of the examples of ad data 1130 may be related to one another. For example, the title 1132 of the advertisement may be the name of the product 1140. The ad data 1130 shown in FIG. 11 is merely exemplary, and the available advertisements may include additional examples of ad data 1130.

The ad data 1130 may include information relevant to the content and topic of an advertisement. Each available advertisement may include its own ad data 1130 which is analyzed by the ad analyzer 1106. The ad data 1130 that is extracted in block 1208 may be analyzed by the ad analyzer 1106 as in block 1210. The ad analyzer 1106 may identify relevant keywords from the ad data 1130 for each available advertisement. The relevant keywords may relate to the topic of a video. In one embodiment, the category 1138, or a sub-category may be the keyword of the advertisement. Likewise, the video analyzer 1104 may identify keywords from the video data 1110 of a video.

In block 1212, the comparator 1102 may compare the analyzed video data 1110 from the video analyzer 1104 with analyzed ad data 1130 from the ad analyzer 1106. The ad analyzer 1106 may determine keywords from the ad data 1130. The comparator 1102 may compare the video keywords with the keywords from each of the available advertisements. Based on the comparison, the comparator 1102 may select a relevant advertisement to be displayed in the video. The comparator 1102 determines which of the available advertisements is similar to the video based on a comparison of the keywords. In one embodiment, the comparator 1102 may compare titles, descriptions, and categories to determine similarity without determining keywords. Alternatively, the video analyzer 1104 may determine one topic from the video data 1110 that is the most relevant and then selects the available advertisements based on that topic.

FIG. 13 illustrates one embodiment of an interface for selecting and inserting an advertisement in a video. In particular, the interface 902 may comprise the adflix editor 502. The adflix editor 502 may be an interface through which the editor 103 may select advertisements to be included in a video. The editor 103 may be provided with a list 1304 of available advertisements. The editor 103 may select no ads 1306 if no advertisement is to be added to the video.

In selecting an advertisement, the editor 103 may choose auto selection 1308 or manual selection 1310. If manual selection 1310 is chosen, the editor 103 may choose from the list 1304 of available advertisements. In one embodiment, the editor may be able to view relevant information for each available advertisement, such as any of the factors for manual ad selection 1001. The manual selection 1310 may be performed by the manual selector 904 as discussed above. The editor 103 may add 1312 an advertisement to the list 1304, or select an advertisement from the list 1304 to add to the video. The editor 103 may also remove 1314 an advertisement from the list 1304, or remove an advertisement from the video.

If auto selection 1308 is chosen, then the auto selector 906 may select a relevant advertisement for a video. In one embodiment, when auto selection 1308 is chosen, the auto selector 906 populates the list 1304 with advertisements that are relevant or similar to the video. The editor may then choose which of those advertisements are added to the video based in part on the manual ad selection factors 1001. Alternatively, the choice of auto selection 1308 may result in the selection of a relevant advertisement to be included in the video, as determined by the auto selector 906.

The adflix editor 502 may include a variety of tabs 1316, which may be used to perform various video editing tasks. The adflix tab is selected, which provides the editor 103 with the ability to add an advertisement to a video. Alternatively, the video may be edited by adding a clip or audio, or the video may have its effects or styles modified. Alternatively, the editing options may be applied to an advertisement which is added to the video. For example, the font or color of a plain text advertisement may be modified. One of the tabs 1316 may include the video editing options 302.

Referring back to FIG. 1, the adflix server 112 may be coupled with the advertiser 116, which may be coupled with the advertiser database 118. The advertiser 116 may be a company or person advertising a product or service, or conveying other information. The advertiser 116 may create advertisements, which are stored in the advertiser database 118 and made available by the adflix server 112 for inclusion in videos. The advertiser 116 may also be referred to as an information provider that not only provides advertisements, but also conveys other information, such as text, graphics, icons, or images. The advertiser 116 may include a server that provides advertisements to the adflix server 112, the video server 108, and/or the user device 104. The advertiser 116 may comprise a general computer system or any of the components as described below with respect to FIG. 14.

In one embodiment, the advertiser 116 pays a fee each time the advertiser's advertisement is displayed in a video, or each time the advertisement is interacted with as discussed with respect to FIG. 10. The fee may be paid to the editor of the video, who includes the advertisement in the video. In one embodiment, the adflix server 112 is coupled with a plurality of advertisers from which it receives a number of advertisements for display. The plurality of advertisers may each have an advertiser database, or may share databases, such as the advertiser database 118. The adflix server 112 may compile and store the advertisements from the advertisers, and provide advertisements through the video server 108. The advertisements that are created and stored in the advertiser database 118 may be of a variety of forms, including any of the ad types 602.

The advertiser database 118 may include available advertisements that are available to the adflix server 112. The advertiser database 118 may also include available advertisements as well as information on size, content, pricing, and location specificity of the advertisements. In one embodiment, the advertiser database 118 may include data regarding the ad type 602, as well as any of the factors 1001 for manual ad selection, which may be used in selecting an advertisement to be included in a video. Further, the ad data 1130 for each advertisement may also be stored in the advertiser database 118 for use in automatic selection of advertisements.

Referring to FIG. 14, an illustrative embodiment of a general computer system is shown and is designated 1400. Any of the components from the system 100 may comprise the computer system 1400, such as the video server 108, or the adflix server 112. The computer system 1400 can include a set of instructions that can be executed to cause the computer system 1400 to perform any one or more of the methods or computer based functions disclosed herein. The computer system 1400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1400 can be implemented using electronic devices that provide voice, video or data communication. Further, while a single computer system 1400 is illustrated, the term “system” shall also be taken to include any collection of systems or sub-systems that individually or jointly execute a set, or multiple sets, of instructions to perform one or more computer functions.

As illustrated in FIG. 14, the computer system 1400 may include a processor 1402, e.g., a central processing unit (CPU), a graphics processing unit (GPU), or both. The processor 1402 may be a component in a variety of systems. For example, the processor 1402 may be part of a standard personal computer or a workstation. The processor 1402 may be one or more general processors, digital signal processors, application specific integrated circuits, field programmable gate arrays, servers, networks, digital circuits, analog circuits, combinations thereof, or other now known or later developed devices for analyzing and processing data. The processor 1402 may implement a software program, such as code generated manually (i.e., programmed).

The computer system 1400 may include a memory 1404 that can communicate via a bus 1408. The memory 1404 may be a main memory, a static memory, or a dynamic memory. The memory 1404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1404 includes a cache or random access memory for the processor 1402. In alternative embodiments, the memory 1404 is separate from the processor 1402, such as a cache memory of a processor, the system memory, or other memory. The memory 1404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1404 is operable to store instructions executable by the processor 1402. The functions, acts or tasks illustrated in the figures or described herein may be performed by the programmed processor 1402 executing the instructions stored in the memory 1404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1400 may further include a display unit 1414, such as a liquid crystal display (LCD), an organic light emitting diode (OLED), a flat panel display, a solid state display, a cathode ray tube (CRT), a projector, a printer or other now known or later developed display device for outputting determined information. The display 1414 may act as an interface for the user to see the functioning of the processor 1402, or specifically as an interface with the software stored in the memory 1404 or in the drive unit 1406.

Additionally, the computer system 1400 may include an input device 1416 configured to allow a user to interact with any of the components of system 1400. The input device 1416 may be a number pad, a keyboard, or a cursor control device, such as a mouse, or a joystick, touch screen display, remote control or any other device operative to interact with the system 1400.

In a particular embodiment, as depicted in FIG. 14, the computer system 1400 may also include a disk or optical drive unit 1406. The disk drive unit 1406 may include a computer-readable medium 1410 in which one or more sets of instructions 1412, e.g. software, can be embedded. Further, the instructions 1412 may embody one or more of the methods or logic as described herein. In a particular embodiment, the instructions 1412 may reside completely, or at least partially, within the memory 1404 and/or within the processor 1402 during execution by the computer system 1400. The memory 1404 and the processor 1402 also may include computer-readable media as discussed above.

The present disclosure contemplates a computer-readable medium that includes instructions 1412 or receives and executes instructions 1412 responsive to a propagated signal, so that a device connected to a network 1420 can communicate voice, video, audio, images or any other data over the network 1420. Further, the instructions 1412 may be transmitted or received over the network 1420 via a communication port 1418. The communication port 1418 may be a part of the processor 1402 or may be a separate component. The communication port 1418 may be created in software or may be a physical connection in hardware. The communication port 1418 is configured to connect with a network 1420, external media, the display 1414, or any other components in system 1400, or combinations thereof. The connection with the network 1420 may be a physical connection, such as a wired Ethernet connection or may be established wirelessly as discussed below. Likewise, the additional connections with other components of the system 1400 may be physical connections or may be established wirelessly.

The network 1420 may include wired networks, wireless networks, or combinations thereof. The wireless network may be a cellular telephone network, an 802.11, 802.16, 802.20, or WiMax network. Further, the network 1420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method for providing an interactive advertisement within a video comprising:
identifying a video to be played;
including the interactive advertisement in the video;
displaying the interactive advertisement within the video while the video is played;
receiving an indication when there is an interaction with the interactive advertisement during the playing of the video; and
displaying additional information associated with the interactive advertisement upon receiving the indication of the interaction.

2. The method of claim 1 wherein the video is displayed in a web page.

3. The method of claim 2 wherein the interactive advertisement is a hyperlink.

4. The method of claim 3 wherein the interaction comprises a selection of the hyperlink by a mouse click of the interactive advertisement.

5. The method of claim 1 wherein the additional information comprises a web page for the advertisement.

6. The method of claim 1 wherein the additional information is related to the interactive advertisement and comprises an additional advertisement within the video.

7. The method of claim 1 wherein the interactive advertisement is an object embedded within the video.

8. The method of claim 7 wherein the object is a product included in the video.

9. A method for interacting with an advertisement in a video comprising:
providing the advertisement during playing of the video;
displaying the advertisement during at least a portion of the video;
detecting an interaction with the advertisement while the advertisement is displayed during the playing of the video; and
providing additional information associated the advertisement in response to the detecting of the interaction with the advertisement.

10. The method of claim 9 wherein the advertisement is a hyperlink.

11. The method of claim 10 wherein the interaction is a selection of the hyperlink by a click of the advertisement.

12. The method of claim 9 wherein the video is played in a web page.

13. The method of claim 12 wherein the providing additional information comprises displaying a web page related to the advertisement in addition to the web page playing the video.

14. The method of claim 9 wherein the providing additional information comprises displaying an additional advertisement.

15. The method of claim 9 wherein the advertisement is an embedded object in the video.

16. The method of claim 9 wherein the advertisement is text displayed in the video.

17. In a computer readable storage medium having stored therein data representing instructions executable by a programmed processor for providing a selectable advertisement within a video, the storage medium comprising instructions operative for:
providing an advertisement comprising a selectable object;
displaying the selectable object during a playing of the video, wherein the selectable object is embedded within the video; and
displaying a page associated with the advertisement upon a selection of the selectable object during the playing of the video.

18. The storage medium of claim 17 wherein the video is played on a web page.

19. The storage medium of claim 18 wherein the selectable object is a link to the page associated with the advertisement.

20. The storage medium of claim 18 wherein the selection comprises a mouse click.

21. The storage medium of claim 17 wherein the page associated with the advertisement is a web page for an advertiser of the advertisement.
